(19) United States
(12) Patent Application Publication
(10) Pub. No.: US 2006/0013227 A1
(43) Pub. Date: Jan. 19, 2006

(54) Method and appliance for distributing data packets sent by a computer to a cluster system

(75) Inventor: Hari Kannan, Sunnyvale, CA (US)

Correspondence Address: COHEN, PONTANI, LIEBERMAN & PAVANE, Suite 1210, 551 Fifth Avenue, New York, NY, 10176, US

(73) Assignee: Fujitsu Siemens Computers Inc., Milpitas, CA (US)

(21) Appl. No.: 11/140,423

(22) Filed: May 27, 2005

Related U.S. Application Data
(63) Continuation of application No. PCT/EP03/13255, filed on Nov. 25, 2003.
(60) Provisional application No. 60/429,700, filed on Nov. 27, 2002.

(51) Int. Cl. H04L 12/28

(52) U.S. Cl. 370/392

(57) ABSTRACT

A method and an apparatus for distributing a data packet sent by a computer via a connection line to a cluster system. The data packet comprises a UDP packet and an identification of the computer the data packet was sent from. After the data packet is received by an at least one second node the identification within said data packet is extracted. It will then be checked whether a data packet comprising the same identification has been previously received and forwarded to one of at least two first nodes. If that check is positive, the data packet is forwarded to one of those at least two first nodes. Otherwise, a new node is selected and the data packet is forwarded to that selected node for data processing. This allows high availability against failovers and also load balancing for UDP connections.

### RELATED APPLICATIONS

This is a continuation of International Application No. PCT/EP2003/013255, filed on Nov. 25, 2003, which claims priority from U.S. provisional application No. 60/429,700 filed Nov. 27, 2002, the content of which is hereby incorporated by reference.

### FIELD OF THE INVENTION

The invention refers to a method and an apparatus for distributing a data packet sent by a computer to a cluster system.

### BACKGROUND OF THE INVENTION

An example for such data packet is the user datagram protocol. The user datagram protocol (UDP) does not have a notion of connection. It is also called a connectionless protocol, because an acknowledgement after UDP packets are received is not required. Two computers connected together over a network using the UDP protocol will send data packets to each other without waiting for an acknowledgement. Packets, which do not reach their destination are lost. Since the UDP packet only includes a small header without complex error correction it is normally used in applications, where high data rates are required.

Especially in scalable internet services (SIS) data connections with the UDP protocol are often used. If a computer sends a UDP packet to a cluster system providing some scalable internet services like WWW, FTP or similar, the cluster system software has to make sure that no UDP packet is lost within the cluster. This is even more important because some applications using the UDP protocol require knowledge about previously sent packets.

“Cluster” is a widely-used term meaning independent computers combined into a unified system through software and networking. At the most fundamental level, when two or more computers are used together to solve a problem, it is considered a cluster. Cluster systems provide convenient and cost-effective platforms for executing complex computation-, data-, and/or transaction-oriented applications. A “node” is a logical and/or physical member of a cluster and is basically the same as a computer. A user manual is available from Fujitsu Siemens Computers, Inc., the assignee of the present invention, titled “PRIMECLUSTER, Concepts Guide (Solaris, Linux),” April 2003 Edition. It provides detailed information about concepts related to cluster systems.

### SUMMARY OF THE INVENTION

One object of the present invention is to provide an apparatus and a method capable of preventing the loss of UDP packets sent to a cluster system.

This and other objects are attained in accordance with one aspect of the present invention directed to method for distributing a data packet sent by a computer via a connection line to a cluster system, wherein the cluster system includes at least two nodes, wherein at least two first nodes comprise a service for processing said data packet and wherein at least one second node comprises means for receiving said data packet, said data packet comprising an UDP-packet and an identification of the computer the data packet was sent from. The method comprises the steps of a) receiving the data packet by the at least one second node, b) retrieving said identification within said data packet, c) checking, whether a data packet comprising the same identification has been received and forwarded to one of the at least two first nodes, d) forwarding the data packet to the one of the at least two first nodes if the previous check is positive, e) selecting a node of the at least two first nodes and forwarding the data packet to said selected node if the previous check is negative, f) creating a first list, said first list comprising entries, said entries comprising said identification of the computer the data packet was sent from and a node identification of the one of the at least two first nodes the data packet was sent to assigned to said identification; and g) creating a second list, said second list comprising entries, said entries comprising the identification of said data packets received by each of the at least one second nodes and further comprising a node identification of the one of the at least two first nodes assigned to said identification

By this method the data packet received by the at least one second node is always forwarded to that node, which previously already received a data packet from the same computer. Thus, data packets belonging to the same session are always forwarded to the correct node. The expression “session” is defined as data packets having an identification of a specific computer the data packet was sent from. Packets sent by the same computer are, therefore, considered to belong to the same session. If a check whether a data packet sent by a specific computer has been previously received is negative then a new node is selected. This method step will result in a new session. Data packets sent again by the same specific computer will then be automatically forwarded to the selected node. Due to different selection algorithm a load balancing of incoming UDP packets can be established.

Another aspect of the invention is directed to an apparatus for distributing data packets sent by a computer to a cluster system. Said data packets comprise a UDP packet and also an identification of the computer the data packet was sent from. The cluster system comprises at least two nodes connected via a cluster network. The apparatus comprises means for processing said data packet in at least two first nodes of the at least two nodes and also comprises means for receiving data packets on an at least one second node of said at least two nodes. Furthermore, the apparatus comprises means for forwarding received data packets to said at least two first nodes and means for selecting a node of said at least two first nodes the data packets have to be forwarded to.

In an embodiment of the invention the means for forwarding and the means for processing the data packet are implemented on different nodes of the at least two nodes. Alternatively the means for forwarding and the means for selecting are implemented on different nodes of the at least two nodes. This allows a better load balancing and gives higher security against hardware failures on one node.

In another embodiment of the invention the data packet to be forwarded is the UDP packet within the data packet received by the at least one second node. In this embodiment of the invention the UDP packet will be extracted from the received data packet by the at least one second node and then forwarded to one of the at least two first nodes.

A further embodiment of the invention includes the step of checking whether a received data packet includes an identification of a computer, of which another data packet was received a specific time earlier. In this embodiment of the invention, a data packet received by the at least one second node is considered to belong to a specific session if another data packet coming from the same computer was received by the same computer only a predefined time gap earlier. In other words, if there is only a predefined time gap between two subsequent packets having the same identification, therefore coming from the same computer, the two subsequent packets will be considered to belong to the same session. Packets belonging to same session are forwarded to the same node, whenever possible. If the gap is greater than the predefined time value, then the received data packet is considered to belong to a new session and might be forwarded to a different node.

In another embodiment of the invention, the at least one second node comprises a first list, wherein the first list comprises entries. The entries comprise the identification of the computer the data packet was sent from as well as a node identification of the node the data packet is forwarded to. Said node identification is assigned to the identification of the computer the data packet was sent from. If a further data packet is received by the at least one second node, the at least one second node will perform the checking by looking for the identification in the first list. If an identical identification is found, it is considered to belong to the same session and the node identification assigned to it is used to forward the data packet. If the identification is not found in the first list, then the received data packet is considered to belong to a new session, a new node will be selected and the data packet will be forwarded to the new selected node.

In a further embodiment of the invention, a second list is created, wherein the second list comprises the identification of data packets received by each of the at least one second nodes and further also comprises a node identification assigned to the identification of said data packets. The embodiment is especially useful, if there are more than just one second node receiving data packets from computers. The second list comprises the identification of the computers the data packets were sent from and also the node identification the packets were forwarded to regardless of the receiving second node. This will allow to identify existing connections even if data packets belonging to the same connection are received by different second nodes.

In another embodiment of this invention, the entries in the first or in the second list comprising the identification of the computers the packets were sent from will be deleted, if no additional data packet having the same identification is received within a specific time. After deletion the data packet is considered to belong to a new connection.

In a further embodiment of the invention, the selecting step comprises the steps of measuring the system load of each of the at least one first node, and selecting the node with the least system load. Alternately, the selecting step comprises the step of selecting a node of the at least one first node with the lowest count of connections. Further alternately, the selecting steps comprises the step of selecting a node of the at least one first node according to a cyclical pattern.

The selection of nodes for new connections is very useful for load balancing.

### BRIEF DESCRIPTION OF THE DRAWINGS

FIG. 1 shows an embodiment of the invention in a cluster system;

FIG. 2 shows the physical structure of a cluster system implementing the invention;

FIG. 3 shows a different embodiment of the invention;

FIG. 4 shows an example of lists used for gateway modules and database modules in an embodiment of the invention;

FIG. 5 shows a list used in service nodes according to an embodiment of the invention;

FIG. 6 shows a flow chart of steps performed in an example of the inventive method;

FIG. 7 shows another flow diagram for performing a second example of the inventive method;

FIG. 8 shows an useful add-on to the inventive method;

FIG. 9 shows another useful add-on to the inventive method.

### DETAILED DESCRIPTION OF THE DRAWINGS

FIG. 2 shows the structure of a cluster system 1, in which the invention is implemented. The cluster 1 comprises four nodes 12, 13, 14, 15 which are connected over a network 17. Network 17 is accessible from the Internet and can be referred to as a public network. Each node is an independent computer comprising at least a memory and a processor unit. An operating system as well as a cluster software is running on each of those nodes. Communication between the nodes is possible via a specific cluster software and the network 17. The cluster 1 also comprises a second communication network 16, which is connected to the nodes 12, 13, 14. Network 16 is accessible from within the network and can be referred to as a private network. The second network 16 connects the nodes to a shared storage device, where data is stored. The storage device 18 can include, for example, a RAID-system (Redundant Array of Independent Disks) comprising a database or a plurality of hard disks. It can also include its own processor unit.

In this embodiment of the invention the cluster system is connected to an internet 21 via a firewall 20. The firewall can be a software module on a specific computer or a router or a hardware firewall. Its functions include packet filtering , IP-masquerading, Spoofing and other similar techniques. The firewall is connected to the cluster network 17. All incoming internet connections are received by the firewall 20, filtered and then sent to the cluster input 11.

The cluster 1 can communicate with a client 22 via the internet 21 if such communication is permitted by the firewall 20. For example, the client 22 can request a worldwide web page from the cluster 1. The request is received by the firewall 20 forwarded to the cluster 1 and then processed by one of the nodes within the cluster.

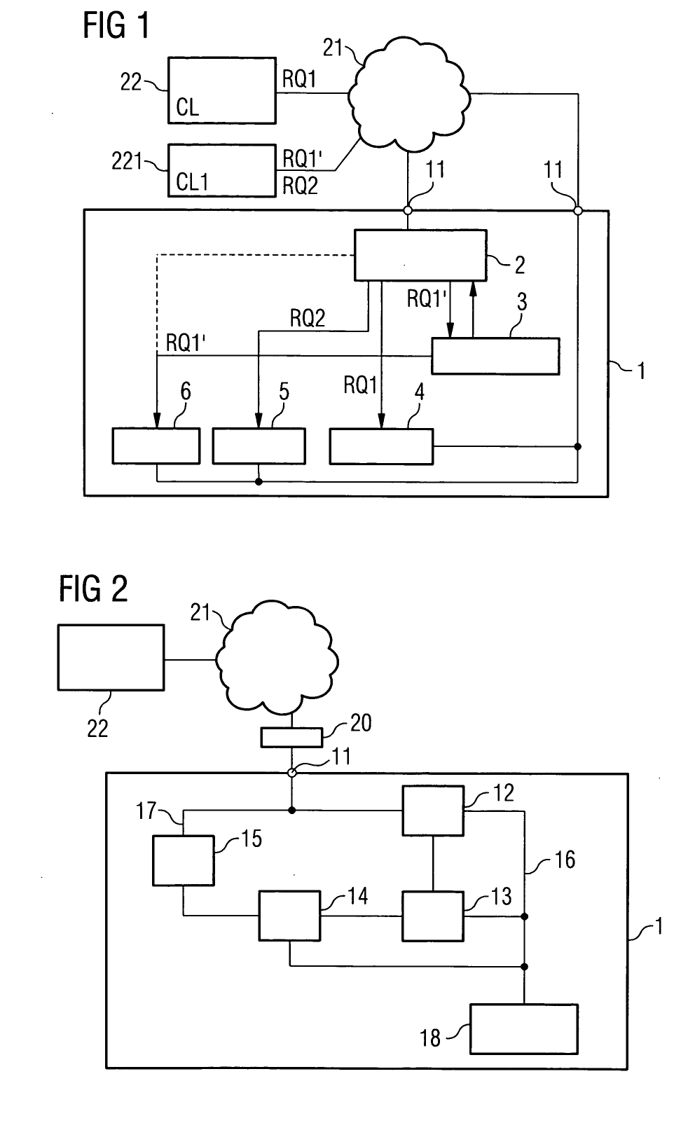

The physical structure of the cluster 1 in FIG. 2 can be replaced by a logical structure of a cluster 1 as shown in the apparatus of FIG. 1. Cluster 1 in FIG. 1 comprises different services. The services can be executed on different nodes, but two or more services can also be executed by one node. It is also possible to spread one service over different nodes. Administration and arrangement of the services on the available nodes is done by a cluster software or a scalable internet services (SIS) software respectively.

In this example of the invention, cluster 1 comprises a gateway service 2. The gateway service 2, is implemented in a specific node, which receives all incoming requests from an external client 22 or 221 respectively. The cluster 1 also comprises different service modules 4, 5 and 6 which are used for processing different requests. The service modules 4, 5 and 6 are also implemented on different physical nodes. For example, the service module 4 and 6 are the same service modules processing the same requests. However the are executed on different nodes. The module 5 is executed on a third node and processes different request. All service modules are implemented in a way to process incoming UDP-requests.

Furthermore, the cluster comprises a database module 3. This database module 3 is used for administrative work, for example load balancing, scheduling service modules on different nodes and other administrative work. The database module is executed on another node for security reasons in order to improve stability of the whole apparatus. The connection and the data packets sent between all modules are established via a logical connection network (e.g. at least one of the physical networks 16 and 17) between the nodes in the cluster system.

In this embodiment of the invention, the gateway module 2 receives a UDP packet RQ1 coming from, for example, the client 22 via the internet 21. The UDP packet RQ1 includes the source address of the client 22 as well as the destination address, in this case the destination address of cluster 1. The source address is defined by an IP address of the client 22 in addition to a port address. Both features together resemble a unique identification used by the apparatus to identify the connection. The destination address is given by the IP address of cluster 1 as well as a cluster port address.

A request is normally send to an IP-address including a port address. For example, all http requests are normally sent to port 80 (e.g. http://127.0.0.1:80 is an “http” request on port 80 to a person's own computer which includes a loopback device with that address). A service is always addressed by the IP-address (addressing the node the service module is executed on) and the port number. In other words, if an operating system receives a packet on port 80, it will foward it to the webserver service module executed on that computer. FTP requests are sent to ports 21 and 22 respectively. Every internet service (HTTP, FTP, telnet, news) is assigned to a specific port. The details of this technology are well known and, thus, no further details are deemed necessary

The gateway module 2 now checks whether a UDP packet having the same source address has been received before. In other words, the gateway module looks for the same IP-address and port number received in a previously packet. If that is the case, then it is assumed that the UDP packet belongs to the same session. It will be forwarded to the same service module which has also received the previous packet.

For example, the UDP packet RQ1 of client 22 has been forwarded by the gateway module 2 to the service module 4 (which, for example, is implemented on node 4). A second UDP packet sent by the client 22 received by the gateway module includes the same IP address of client 22. If it includes also the same port number, it will be forwarded by the gateway module 2 to the service module 4 on node 4 as well.

An additional but new UDP packet RQ1′ is now sent by the client 221 and received by the gateway module 2. Since the gateway module 2 has not received any UDP packets from that client before, the gateway module 2 considers the received packet to belong to a new session. Therefore the packet RQ1′ is forwarded to the database module 3.

The database module 3 will make the decision as to which node the packet will be forwarded for processing. The decision is performed by a scheduling algorithm implemented in the database module 3.

The problem addressed by the scheduling algorithm can be described as follows. A new UDP-packet is received by a gateway module and identified as a new packet belonging to a new session. In such a case the problem arises which service module on which node(s) should process this UDP-packet. If it is assumed that only one service module on one node exists that is capable of processing the package, then the decision is a simple one, namely that the gateway module will forward the UDP-packet to that service module. If it is assumed that three modules on three different nodes are capable of processing the received packet, then the question is to which node and service module the packet should be forwarded. This problem is solved by the scheduling algorithm, which include instructions on how to proceed when receiving new packets. For example, the instructions can be that the packet should always be forwarded to the next node in a predetermined repeating sequence of nodes. As an alternative, the load is measured on the nodes which execute the service module, and the packet is forwarded to the node with the least load at the particular time when the packet arrives. Alternatively, there might be some user-set priority. There are different possibilities for such “decision routines” within the gateway module.

There are more possibilities for the scheduling algorithm. One possibility for the database module is to look for the IP address of the client 221, and to forward the packet to a service module on a node which has received a packet from the same IP address as before. This is called a client-based scheduling algorithm. Yet another possibility is to count the already existing connections of a node and choose the node with the least connections. Yet another possibility is called spill over, wherein a replacement node is chosen as soon as the system load on the original node exceeds a predefined value. It is possible to combine the scheduling method disclosed herein or to find other scheduling algorithms. By using a specific algorithm or switching between different methods, load balancing is implemented.

If the node chosen by the database module 3 is available, the UDP packet is forwarded to that node. Otherwise, a fallback node is checked for availability. Furthermore, the database module 3 will send the node's identification to the gateway module 2, thereby telling the gateway module 2 to forward additional UDP packets from the same connection to the selected node.

In this embodiment of the invention, the UDP packet RQ1 from the client 22 is forwarded to the service module 4, while the first UDP packet RQ1′ from client 221 is forwarded by the gateway module 2 first to the database module 3 and then forwarded to the service module 6. All further UDP packets from client 221 will be forwarded by the gateway module 2 automatically to the service module 6 on node 6.

Administration of the different sessions is implemented in the gateway module 2 as well as in the database module 3 by lists including the destination address and the source address. Those lists are shown in FIG. 4.

The left list LG is used for the gateway module 2. The list LG comprises five columns with three rows entries. The first column IPP includes the port number of the source address. In the second column, IPA includes the IP address of the source where the UDP packets were sent from are stored. In the next two columns DPP, DIP include the port number as well as the IP address of the cluster which received the incoming UDP packets are stored. The last column ID includes the address of the node the UDP packet is forwarded to.

In the example, the list LG of the gateway module 2 as well as the list LD of the database module 3 comprise three entries. Two entries have the port number 80. One of those entries has the IP-address CL of client 22, while the other entry includes the IP-address CL1 of client 221. One entry states that a UDP packet with port number 82 and IP-address CL1 of client 221 was received by the gateway module 2 and forwarded to the service node N5.

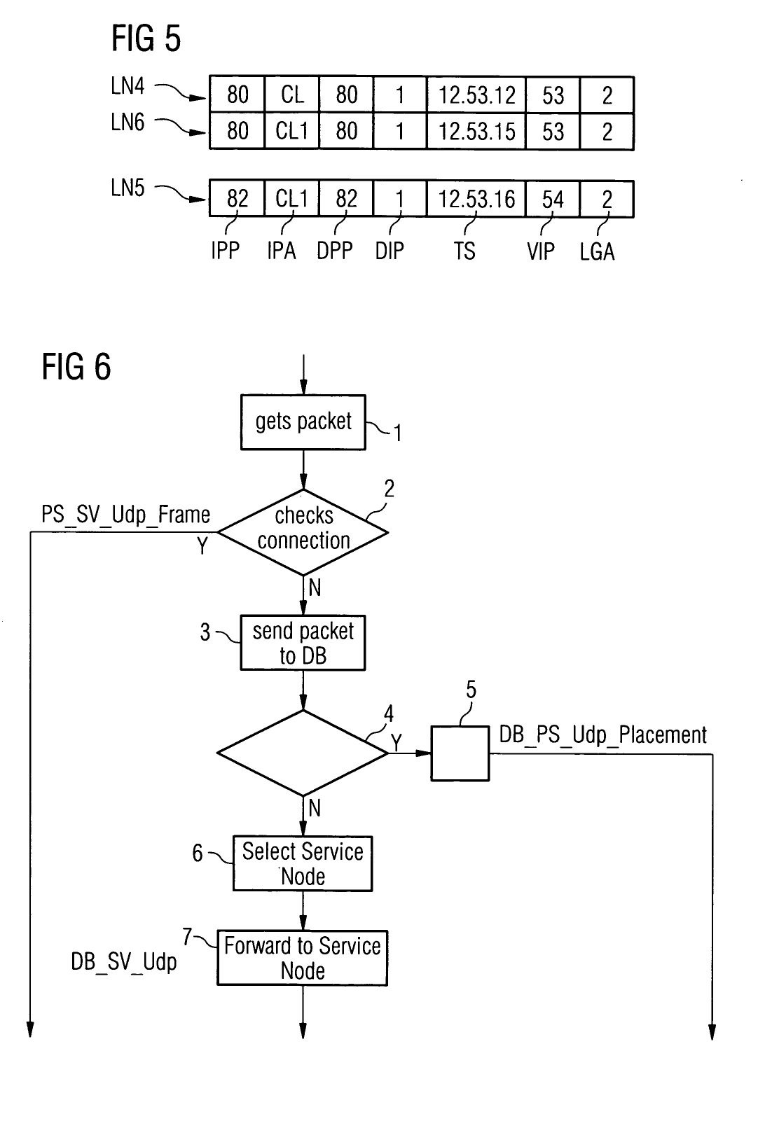

FIG. 5 shows the list of entries of the service modules 4, 5 and 6. The entries are stored on the node by the operating system. The lists LN4, LN5 and LN6 also comprise the source port number IPP, the source IP address IPA as well as the destination port number DPP and the destination IP address DIP. Furthermore, it comprises a time stamp TS. The time stamp is a time value, on which the last UDP packet has been received by the node. In the depicted example, the list LN4 of node N4 has the oldest time stamp followed by list LN6 of node N6 and then by node N5. The time stamp will be updated if a further packet is received by the service module. Furthermore, each list comprises a virtual IP address for internal communication as well as a list of gateways LGA the packets could have come from.

More specifically, when forwarding the UDP-packet to a node within the cluster, the gateway module adds its own IP-adress or an identifier. This identifier is stored as an LGA, so that the node and the sevice module know, for example, to which gateway module it has to send its answer.

Virtual IP-addresses are aliases. This means that a module/application/service on a physical node can be addressed by more than just the address, e.g. an http request to one's own computer on port 80 is http://127.0.0.1:80, and http://127.0.0.1:8080 is a further http request now on port 8080 on the same computer.

If packets considered as new sessions are received, the database modules and the gateway modules will add new entries with the corresponding identifications. Considering the time stamp, the service modules will decide when a session has to be closed or can be considered inactive. They can do that by comparing the time stamp with the actual time. If the result is bigger than a predefined value, they will delete the corresponding entries and send messages to the database and/or gateway module. Those modules will also delete the corresponding entries.

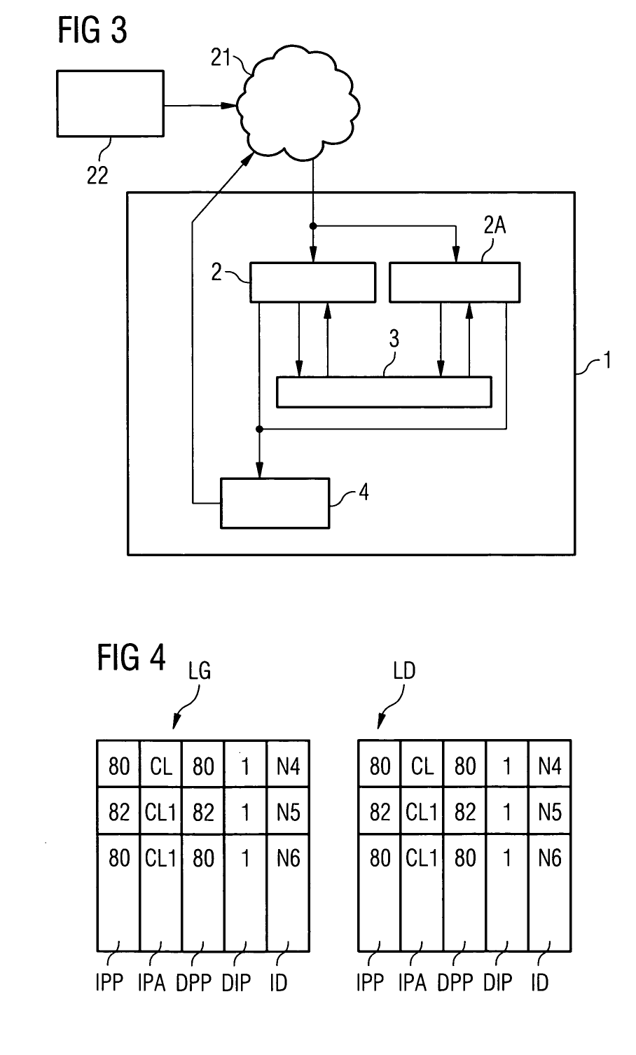

FIG. 3 shows another embodiment of the invention. In this embodiment, the cluster 1 comprises two gateway modules 2 and 2A implemented on two different nodes. A new UDP packet is received by the gateway 2 from the internet 21 and the client 22. Since no previous UDP packet has been received by the client 22, the gateway 2 sends in this example only the IP address as well as the port number of client 22 included in the received UDP package to the database module 3. The database module 3 chooses a new service module, in this case module 4, and sends identification of the node, on which service module 4 is executed, back to the gateway module 2. The gateway module 2 forwards the UDP packet to service module 4 for data processing.

In a later stage, an additional UDP packet is sent by the client 22 to the cluster 1. However, it is now received by the gateway 2A due to a failure of gateway 2. Since no UDP packet from client 22 has been received by gateway 2A before, gateway 2A considers the UDP packet as a new session. It forwards the address to the database module 3. However, database module 3 already has an entry of client 22 and the corresponding port number. It will therefore not choose a service module but reply to the gateway 2A with the node identification of the node, on which service module 4 is running. The gateway 2A will then forward the UDP packet to service module 4 or to that node respectively. In a cluster system, this allows the establishment of different gateways without having the problem that UDP packets coming from the same client are forwarded to different nodes for processing.

An embodiment of the inventive method is shown in FIG. 6. In step 1, the gateway module receives a UDP packet and extracts the source IP address as well as the source port number. In step 2, it checks whether a session given by a previously received packet exists. It does that by looking for an entry in its list. If a packet from the same source was already previously received, the UDP packet is forwarded directly to the service module for processing by PS_SV_Udp_Frame.

If that is not the case, the gateway module will send, in step 3, the UDP packet to the database module or database node. The session check in step 2, done by the gateway module or gateway node, will fail if the received packet belongs to a new session or the packet arrived on a new gateway. Another possibility for failure occurs when the gateway was changed by the user side or the original gateway had a failure and a new gateway was selected. Furthermore, it could also be possible that the gateway module has already forwarded a previous packet to the database module for scheduling, but has not yet received a response from the database module.

In step 4, the database module will check whether an entry for a session exists. If the result is positive, it will update the gateway module by sending a message DB_PS_Udp_Placement including the node's identification, and additional UDP packets from the same session have to be forwarded to the same selected node. This is done in step 5.

If the database module does not find an entry for a session, it will then select in step 6, according to the scheduling algorithm, a new service module for the session. The identification of the selected module and its associates node(s) is then forwarded to the gateway module in order to make the necessary session entries. For successive frames of this session a new check will be positive. Additionally, the database module will forward the UDP packet to the service node in step 7 by DB_SV_Udp_Frame indicating the first packet of a new session.

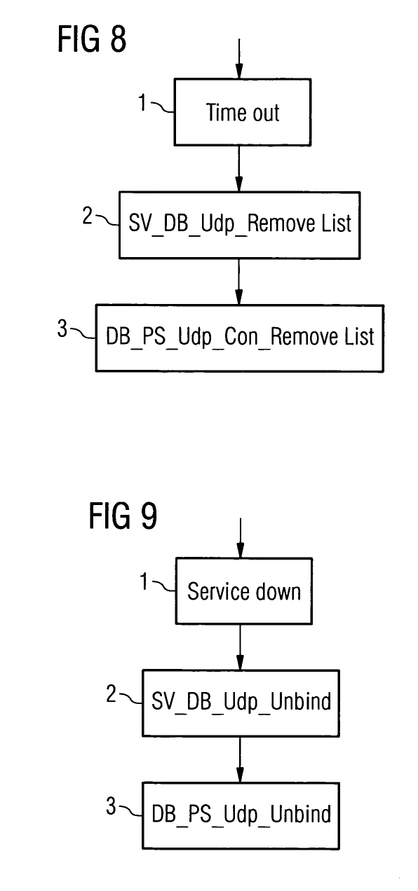

In FIG. 8, an extension of the inventive method handling old connections is shown. The service module processing UDP packets needs to decide whether a session is obsolete or still active. For this purpose the time stamp TS in the service nodes lists in FIG. 5 are used. After a predefined session time expires and no additional UDP packets belonging to the session are received, the service module cleans up the list by deleting entries considered inactive in step 1. Additionally, the service node forwards a list of sessions that have been inactive for the predefined time to be cleaned up by the database module as seen in step 2 of FIG. 8. This is done by sending the message SV_DB_Udp_Con_Remove_List together with the list. The database list is updated and the list is forwarded using DB_SV_Udp_Con_Remove_List to the gateway module by the database module in step 3. The gateway module will then delete the corresponding entries. Incoming UDP packets comprising the same IP address and port number are now considered to be new sessions.

Furthermore, FIG. 9 shows an implementation handling failure of a service on a service node. If a service module on a node fails, for example if the node crashes, a message is sent from the node to the database module in order to clean up all entries in the database module that correspond to that service. This is done in step 2 by sending SV_DB_Udp_Unbind. Upon receiving such message, the database module will remove the node identification from the list of possible nodes capable of processing the UDP packets. After cleaning up all entries in the database module lists the database module will forward all necessary information to the gateway module in step 3 using DB_PS_Udp_Unbind. The gateway module will delete all session entries with that node entry.

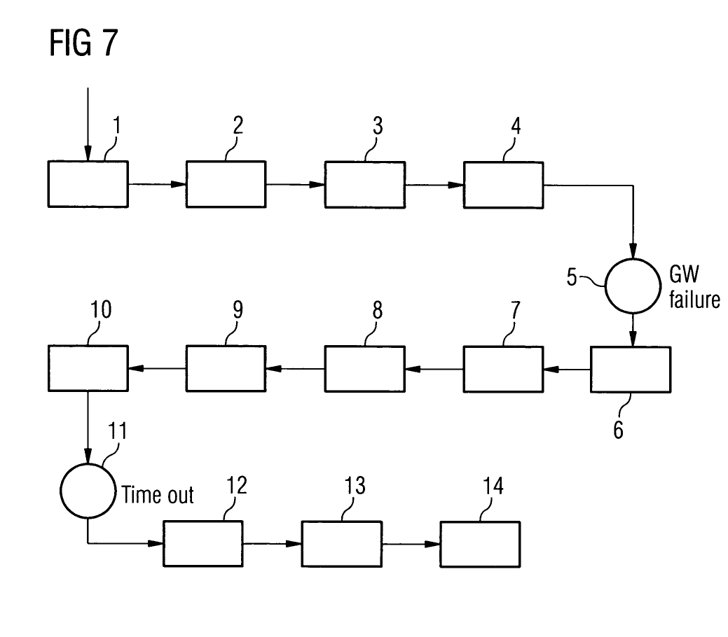

In FIG. 7, an example for such method is depicted. In step 1, a new UDP packet is received by the gateway module and considered as a new session. Since the gateway module does not have any entry associated with the identification in the UDP packet, it forwards the UDP packet to the database module in step 2, wherein the database module selects a node according to the scheduling algorithm for processing the UDP packet. The UDP packet is forwarded to the selected node by the database module and the database module also updates the gateway module by sending the node's identification, as shown in Step 3.

Other UDP packets from the same source received by the gateway module are forwarded to the service node automatically in step 4. In step 5 the gateway node fails. A new gateway is automatically selected in step 6 by the underlying cluster software. The new selected gateway now receives a UDP packet from the same session as in step 4. However, the newly selected gateway does not have an entry for that session. Hence, it forwards the UDP packet to the database module in step 8. The database module also checks its sessions and finds an entry with the same IP entry and the same port number. It will then simply return the appropriate service node's identification to the new selected gateway module in step 9 and forward the UDP packet to that node in step 10.

The service node now does not receive any UDP packets from that specific IP address and port number for some time and, therefore, considers the session inactive in step 11 due to time expiration. It will delete the corresponding entry and forward the entry to be deleted to the database module in step 12. The database module will clean up all entries corresponding to that session and forward the same list to the gateway module in step 13. After cleaning up all existing sessions, the node is able to unbind from the cluster by telling the database module not to use this node for future scheduling, as per step 14.

Due to the redundant information in the database module it will be possible to route incoming sessions to the same service node for processing, even if a gateway node fails. It is useful to implement a backup database. The backup database also collects the session information from all service nodes which allows a smooth failover in case of a failure of the database module. When a service node fails all existing sessions to the failed node would also fail. Future packets for that specific node would be routed as though they were new sessions. The database module will clean up its table for the session entries that correspond to the service node if the service node fails. The timeout value after incoming UDP packets are assumed to belong to a new session can be specified on a service basis as well as on a node or on a cluster-wide basis. This method and apparatus which can be implemented in a cluster software or in a scalable internet service enables distribution and rerouting of UDP packets with high availability.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

I claim:

1. Method for distributing a data packet sent by a computer via a connection line to a cluster system, wherein the cluster system includes at least two nodes, wherein at least two first nodes comprise a service for processing said data packet and wherein at least one second node comprises means for receiving said data packet, said data packet comprising an UDP-packet and an identification of the computer the data packet was sent from, wherein the method comprises the steps of:
a) receiving the data packet by the at least one second node;
b) retrieving said identification within said data packet;
c) checking, whether a data packet comprising the same identification has been received and forwarded to one of the at least two first nodes;
d) forwarding the data packet to the one of the at least two first nodes if the previous check is positive;
e) selecting a node of the at least two first nodes and forwarding the data packet to said selected node if the previous check is negative;
f) creating a first list, said first list comprising entries, said entries comprising said identification of the computer the data packet was sent from and a node identification of the one of the at least two first nodes the data packet was sent to assigned to said identification; and
g) creating a second list, said second list comprising entries, said entries comprising the identification of said data packets received by each of the at least one second nodes and further comprising a node identification of the one of the at least two first nodes assigned to said identification;

2. Method of claim 1, wherein the data packet to be forwarded is the UDP-packet within the data packet received by the at least one second node.

3. Method of claim 1, wherein step c) comprises the step of checking whether a data packet comprising the same identification has been previously received and forwarded to the one of the at least two first nodes before a defined timeframe.

4. Method of claim 1, wherein the first list is used in step d) to identify the node to which the data packet has to be forwarded.

5. Method of claim 1, wherein entries comprising the identification will be deleted from the first and/or second list, if no data packet with said identification is received within a specific time frame.

6. Method of claim 1, wherein the selection in step e) comprises the steps of:
measuring the system load each of the at least one first node and select the node with the least system load; or
selecting a node of the at least on first node with the lowest count of connections.

7. Method of claim 1, wherein the identification of the computer comprises the IP-address of the computer and a port address.
